(19) United States
(12) Patent Application Publication
(10) Pub. No.: US 2007/0277179 A1
(43) Pub. Date: Nov. 29, 2007

(54) Information Processing Apparatus, Communication Processing Method, And Computer Program

(76) Inventor: Tomoyuki Suzuka, Chiba (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/580,847

(22) PCT Filed: Sep. 26, 2005
(86) PCT No.: PCT/JP05/17648

§ 371 Date: Mar. 15, 2007

(30) Foreign Application Priority Data
Sep. 29, 2004 (JP) 2004-283531
May 25, 2005 (JP) 2005-152788

(51) Int. Cl. G06F 9/54; G06F 9/46

(52) U.S. Cl. 719/313

(57) ABSTRACT

A method and apparatus performing smooth message transfer between operating systems (OS's) are provided. In a multi-OS environment, message transfer control is performed by switching a message area of a physical address space from a mapping state to a message area in a logical partition address space in a message transmitting OS to a mapping state to a message area in a logical partition address space in a message receiving OS. A socket associated with a file descriptor is generated, a virtual file accessible via the socket is set, and then message transfer is performed using mapping between the virtual file and the message area of the physical address space.

### TECHNICAL FIELD

The present invention relates to an information processing apparatus, a communication processing method, and a computer program and, in particular, to an information processing apparatus, a communication processing method, and a computer program for controlling message transfer between OS's in a multi OS (OS) that performs a process using a plurality of OS's (OS's).

### BACKGROUND ART

In a multi OS (OS) having a plurality of OS's in a single system, each OS can execute respective process and hardware common to the system, such as a CPU and a memory is successively switched in time sequence.

Scheduling of processes (tasks) of a plurality of OS's is executed by a partition management software program, for example. If an OS(α) and an OS(β) coexist in a single system with the process of OS(α) being a partition A and the process of OS(β) being a partition B, the partition management software program determines the scheduling of the partition A and the partition B, and executes the process of the OS's with the hardware resources allocated based on the determined scheduling.

Patent Document 1 discloses a task management technique of a multi OS system. According to the disclosure, tasks to be executed by a plurality of OS's are scheduled with a priority placed on a process having urgency.

When message transfer is performed among a plurality of OS's coexisting in a system, a message channel connecting OS's is generated. Each OS needs to set up a communication interface for message channel connection. If the OS's communicating via the message channel are different from each other, limitation is imposed on communication interface specifications, and an overhead is generated due to communications between different types of OS's.

[Patent Document 1] Japanese Unexamined Patent Application Publication No. 2003-345612

### DISCLOSURE OF INVENTION

[Problems to be Solved by the Invention]

The present invention has been developed in view of the above-mentioned problem. It is an object of the present invention to provide an information processing apparatus, a communication processing method, and a computer program for smoothly performing inter-OS communications in a multi-OS environment having a plurality of OS's without causing extra overhead.

[Means for Solving the Problems]

In accordance with a first aspect of the present invention, an information processing apparatus includes a plurality of operating systems (OS's). The plurality of OS's include a control OS controlling communications between the plurality of OS's. The control OS controls message transfer between logical partitions set up for respective OS's, by switching a message area in a physical address space from a mapping state to a message area in a logical partition address space in a message transmitting OS to a mapping state to a message area in a logical partition address space in a message receiving OS.

In the information processing apparatus of one embodiment of the present invention, at least one of the communication executing OS's in communication operation generates a socket associated with a file descriptor identified by a file system managed by own OS, generates a virtual file accessed via the socket, and accesses the message area in the physical address space via the virtual file.

In the information processing apparatus of one embodiment of the present invention, the communication executing OS in communication operation using the socket acquires an identifier of the virtual file associated with the socket, and performs one of a message write operation and a message read operation using the virtual file identified by the acquired virtual file identifier.

In the information processing apparatus of one embodiment of the present invention, at least one of the communication executing OS's in communication operation generates a socket associated with a file descriptor identified by a file system managed by own OS, and maps the message area in the physical address space to an address space of a process via the socket so that the process directly accesses the message area.

In the information processing apparatus of one embodiment of the present invention, at least one of the communication executing OS's in communication operation generates a socket associated with a file descriptor identified by a file system managed by own OS, and maps the message area in the physical address space to an address space of a logical partition corresponding to the communication executing OS via the socket in order to access the message area.

In the information processing apparatus of one embodiment of the present invention, the communication executing OS in communication operation using the socket sets an identifier of service corresponding to the socket, and sets communication permission corresponding to the service.

In the information processing apparatus of one embodiment of the present invention, the communication executing OS in communication operation using the socket performs a reception monitoring process on a message via the socket.

In the information processing apparatus of one embodiment of the present invention, the communication executing OS performs the reception monitoring process on the message via the socket by applying a select system call.

In accordance with a second aspect of the present invention, a communication processing method of an information processing apparatus storing a plurality of operating systems (OS's), includes steps of setting a message area in a physical address space to a mapping state to map to a message area in a logical partition address space of a message transmitting OS, and releasing the mapping state and setting the message in the physical address space to a mapping state to map to a message area in a logical partition address space of a message receiving OS.

In the communication processing method of one embodiment of the present invention, at least one of the communication executing OS's performing message transfer generates a socket associated with a file descriptor identified by a file system managed by own OS, generates a virtual file accessed via the socket, and accesses the message area in the physical address space via the virtual file in order to perform message transfer.

In the communication processing method of one embodiment of the present invention, the communication executing OS in communication operation using the socket acquires an identifier of the virtual file associated with the socket, and performs one of a message write operation and a message read operation using the virtual file identified by the acquired virtual file identifier.

In the communication processing method, preferably, at least one of the communication executing OS's in communication operation generates a socket associated with a file descriptor identified by a file system managed by own OS, and maps the message area in the physical address space to an address space of a process via the socket so that the process directly accesses the message area.

In the communication processing method of one embodiment of the present invention, at least one of the communication executing OS's in communication operation generates a socket associated with a file descriptor identified by a file system managed by own OS, and maps the message area in the physical address space to an address space of a logical partition corresponding to the OS via the socket in order to access the message area.

In the communication processing method of one embodiment of the present invention, the communication executing OS in communication operation using the socket sets an identifier of service corresponding to the socket, and sets communication permission corresponding to the service.

In the communication processing method of one embodiment of the present invention, the communication executing OS in communication operation using the socket performs a reception monitoring process on a message via the socket.

In the communication processing method of one embodiment of the present invention, the communication executing OS performs the reception monitoring process on the message via the socket by applying a select system call.

In accordance with a third aspect of the present invention, a computer program for controlling communications in an information processing apparatus storing a plurality of operating systems (OS's), includes steps of setting a message area in a physical address space to a mapping state to map to a message area in a logical partition address space of a message transmitting OS, and releasing the mapping state and setting the message area in the physical-address space to map to a message area in a logical partition address space of a message receiving OS.

In accordance with a fourth aspect of the present invention, a computer program for controlling communications in an information processing apparatus storing a plurality of operating systems (OS's), includes steps of generating a socket associated with a file descriptor identified by a file system managed by own OS, generating a virtual file accessed via the socket, and accessing the message area in the physical address space via the virtual file.

In accordance with a fifth aspect of the present invention, a computer program for controlling communications in an information processing apparatus storing a plurality of operating systems (OS's), includes steps of generating a socket associated with a file descriptor identified by a file system managed by own OS, mapping the message area in the physical address space to an address space of a process via the socket, and accessing directly the message area.

The computer program of one embodiment of the present invention is provided, to a general-purpose computer system executing a variety of program code, in a computer-readable storage medium, such as a CD, an FD, or a MO, or a communication medium such as network. By providing the computer program in a computer readable manner, the computer system performs process responsive to the computer program.

These and other features, and advantages of the present invention will become obvious from the following description of the present invention and the accompanying drawings. In the context of the description of the present invention, the system refers to a logical set of a plurality of apparatuses, and is not limited to an apparatus that houses elements within the same casing.

[Advantages]

In accordance with embodiments of the present invention, the control OS performing communication control is set up among OS's in a multi-OS environment where a plurality of OS's coexist. The control OS controls message transfer between logical partitions set corresponding to OS's. The control OS performs message transfer control by switching the message area in the physical address space from the mapping state to the message area in the logical partition address space in the message transmitting OS to the mapping state to the message area in the logical partition address space in the message receiving OS. Smooth communications are thus possible among different OS's.

In accordance with embodiments of the present invention, the OS generates the socket associated with the file descriptor identified by the file system managed by own OS, generates the virtual file accessed via the socket, and accesses the message area in the physical address space via the socket to transmit and receive messages. Message passing is performed using a general socket among different OS's.

In accordance with embodiments of the present invention, the communication executing OS generates the socket associated with the file descriptor identified by the file system managed by own OS, and maps the message area in the physical address space to the address space of the process via the socket so that the process directly accesses the message area. Message passing is performed using a general socket among different OS's. The process can thus access the message area with a small overhead involved.

In accordance with embodiments of the present invention, the identifier of the service corresponding to the socket is set so that communication permission is set for the service. The reception monitoring process is performed via the socket using the select system call.

### BRIEF DESCRIPTION OF THE DRAWINGS

FIG. 1 is a block diagram of an information processing apparatus of the present invention.

FIG. 2 illustrates a processor module in the information processing apparatus.

FIG. 3 illustrates the structure of an operation system of the information processing apparatus in accordance with the present invention.

FIG. 4 illustrates a communication process between guest OS's.

FIG. 5 illustrates address mapping in communications via a message channel.

FIG. 6 illustrates a communication process sequence between guest OS's.

FIG. 7 illustrates a communication process between a system control OS and a guest OS in communications using a virtual file.

FIG. 8 illustrates a process based on a system call executed in communications between the system control OS and the guest OS when the virtual file is used.

FIG. 9 is a flowchart of the communication process executed between the system control OS and the guest OS when the virtual file is used.

FIG. 10 illustrates a communication process executed between the system control OS and the guest OS when the virtual file is not used.

FIG. 11 illustrates a process based on a system call executed in communications between the system control OS and the guest OS when the virtual file is not used.

FIG. 12 is a flowchart of the communication process executed between the system control OS and the guest OS when the virtual file is not used.

### BEST MODE FOR CARRYING OUT THE INVENTION

An information processing apparatus, a communication processing method, and a computer program of the present invention are described below with reference to the drawings.

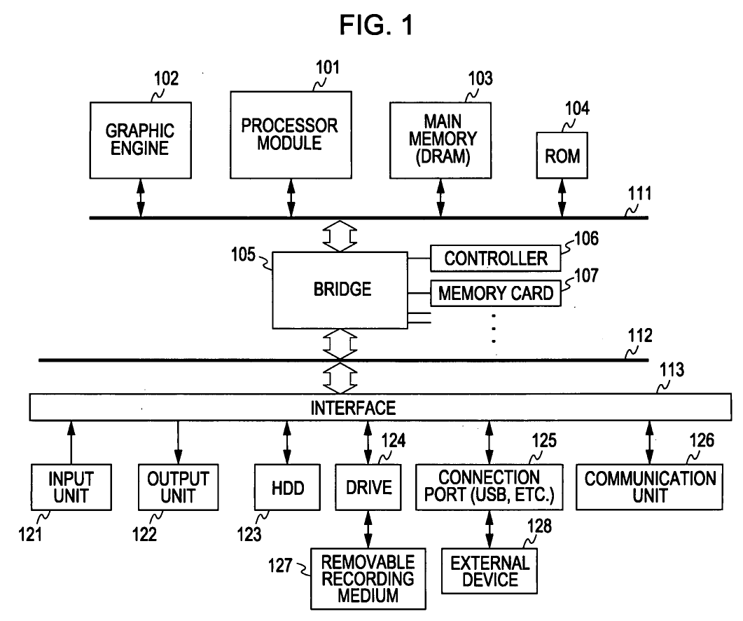

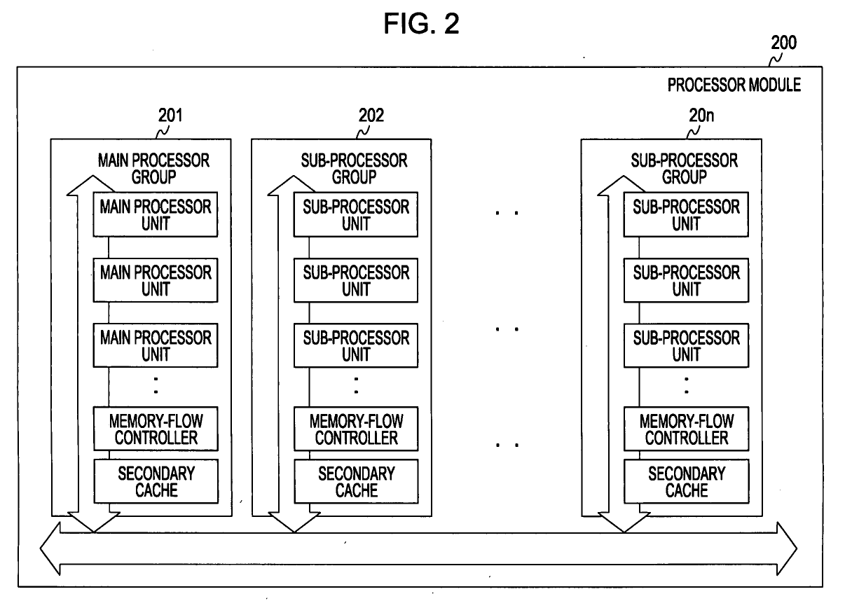

The hardware structure of the information processing apparatus of the present invention is described below with reference to FIG. 1. A processor module 101 includes a plurality of processing units, and processes data in accordance with a variety of programs stored in a ROM (read-only memory) 104 and an HDD (hard disk drive) 123, including operating systems (OS's) and application programs running on the OS. The processor module 101 will be described later with reference to FIG. 2.

In response to a command input via the processor module 101, a graphic engine 102 generates data to be displayed on a screen of a display forming an output unit 122, for example, performs a 3D graphic drawing process. A main memory (DRAM) 103 stores the program executed by the processor module 101 and parameters that vary in the course of execution of the program. These elements are interconnected via a host bus 111 including a CPU bus.

The host bus 111 is connected to an external bus 112, such as a PCI (peripheral component interconnect/interface) bus via a bridge 105. The bridge 105 controls data inputting and outputting between the host bus 111, the external bus 112, a controller 106, a memory card 107, and other devices.

An input unit 121 inputs information to an input device, such as a keyboard and a pointing device, operated by a user. An output unit 122 includes an image output unit, such as one of a liquid-crystal display and a cathode ray tube (CRT), and an audio output device such as a loudspeaker.

The HDD (hard disk drive) 123 drives a hard disk loaded therewithin, thereby recording or playing back a program to be executed by the processor module 101 and information.

A drive 124 reads data and programs stored in a loaded removable recording medium 127, such as a magnetic disk, an optical disk, a magneto-optic disk, a semiconductor memory, or the like, and supplies the data and the programs to a main memory (DRAM) 103 via an interface 113, the external bus 112, the bridge 105, and the host bus 111.

A connection port 125 connects to an external device 128, and may include a USB, an IEEE 1394 bus, or the like. The connection port 125 is connected to the processor module 101 via the interface 113, the external bus 112, the bridge 105, and the host bus 111. A communication unit 126, connected to a network, transmits data supplied from the HDD 123 or the like, and receives data from the outside.

The structure of the processor module is described below with reference to FIG. 2. As shown, a processor module 200 includes a main processor group 201 including a plurality of main processor units, and a plurality of sub-processor groups 202 thorough 20n, each including a plurality of sub-processor units. Each group further includes a memory controller and a secondary cache. The processor groups 201 through 20n, each including eight processor units, for example, are connected via one of a crossbar architecture and a packet exchange network. In response to a command of the main processor of the main processor group 201, at least one sub-processor in the plurality of sub-processor groups 202 through 20n is selected to perform a predetermined program.

The memory-flow controller in each processor group controls data inputting and data outputting to the main memory 103 of FIG. 1. The secondary cache serves as a memory area for process data in each processor group.

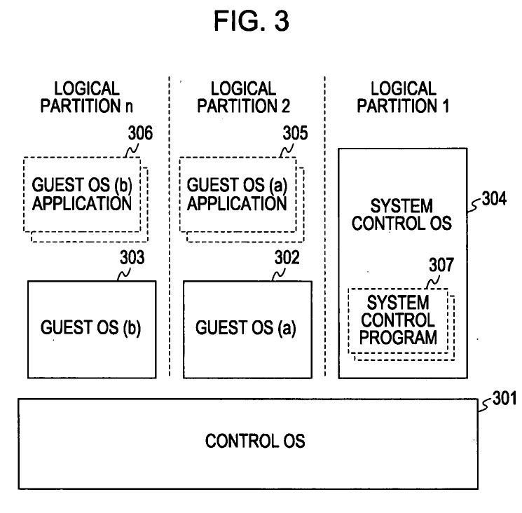

The operating systems (OS's) of the information processing apparatus of the present invention are described below with reference to FIG. 3. The information processing apparatus of the present invention has a multi operating system where a plurality of operating systems (OS's) are included. The multi-OS information processing apparatus has a plurality of OS's arranged in a logical layered structure as shown in FIG. 3.

As shown in FIG. 3, a control OS 301 is arranged at a lower layer. A plurality of sub OS's 302, 303, and 304 are arranged at upper layers. The sub OS's 302 and 303 are guest OS's, and the sub OS 304 is a system control OS. Together with the system control OS 304, the control OS 301 forms a logical partition as an execution unit of each process executed by the processor module 101 discussed with reference to FIGS. 1 and 2, and allocates system hardware resources (for example, main processors, sub-processors, memories, and devices, as computing resources) to each logical partition.

The guest OS's 302 and 303 as the sub OS's are a gaming OS, Windows (trademark), Linux (trademark), etc, and operate under the control of the control OS 301. Although only two guest OS's 302 and 303 are shown in FIG. 3, the number of guest OS's is not limited to two.

The guest OS's 302 and 303 operate within the logical partitions set by the control OS 301 and the system control OS 304. The guest OS's 302 and 303 process a variety of data using hardware resources such as main processors, sub-processors, memories, and device, each allocated to the logical partition.

The guest OS(a) 302 uses the hardware devices including a main processor, a sub-processor, a memory, and a device allocated to the logical partition 2 set up by the control OS 301 and the system control OS 304, thereby executing an application program 305 corresponding to the guest OS(a) 302. The guest OS(b) 303 uses the hardware resources including a main processor, a sub-processor, a memory, and a device allocated to a logical partition n, thereby executing an application program 306 corresponding to the guest OS(b) 303. The control OS 301 provides a guest OS programming interface required to execute the guest OS.

The system control OS 304 as one of the sub OS's generates a system control program 307 containing logical partition management program, and performs operation control responsive to the system control program 307 together with the control OS 301. The system control program 307 controls system policy using a system control program programming interface. The system control OS 304 is supplied with the system control program programming interface by the control OS 301. The system control program 307 permits flexible customization, for example, setting an upper limit on resource allocation.

The system control program 307 controls the behavior of the system using the system control program programming interface. For example, the system control program 307 produces a new logical partition, and starts up a new guest OS at the logical partition. In a system where a plurality of guest OS's are operating, the guest OS's are initiated in the order programmed in the system control program 307. The system control program 307 can receive and examine a resource allocation request issued from the guest OS before being received by the control OS 301, modify the system policy, and deny the request itself. In this way, no particular guest OS monopolizes the resources. A program into which the system policy is implemented is the system control program.

The control OS 301 allocates a particular logical partition (for example, the logical partition 1 as shown in FIG. 3) to the system control OS 304. The control OS 301 operates in a hypervisor mode. The guest OS operates in a supervisor mode. The system control OS 304 and the application program operate in a problem mode (user mode).

The logical partition is an entity receiving a resource allocation in the system. For example, the main memory 103 is partitioned into several areas (see FIG. 1), and each logical partition is granted the right to use the respective area. The types of resources allocated to the logical partitions are listed below.

a) Physical processor unit usage time

b) Virtual address space

c) Memory accessible by program operating in a logical partition

d) Memory used by the control OS to manage the logical partition

e) Event port

f) Right to use device

g) Cache partition

h) Right to use bus

As previously discussed, each guest OS operates within the logical partition. The OS monopolizes the resources allocated to the logical partition to process a variety of data. In many cases, one partition is produced for a guest. OS, on a per guest OS basis, functioning on the system. Each logical partition is assigned a unique identifier. The system control OS 304 manages the system control program generated as logical partition management information by associating the system control program to the identifier.

The logical partition is generated by the control OS 301 and the system control OS 304. Immediately after production, the logical partition has no resources, and with no limitation set on available resources. The logical partition takes one of two states, an active state and an end state. The logical partition immediately after production takes an active state. The logical partition is transitioned into the end state in response to a request of a guest OS operating in the logical partition, and stops all logical processors allocated to the logical partition.

The logical processor is the one allocated to the logical partition, and corresponds to any physical processor, namely, a processor within a processor group of FIG. 2. The logical processor and the physical processor are not always related to each other in one-to-one correspondence. A single logical processor can correspond to a plurality of physical processors. Alternatively, a plurality of logical processors can correspond to a single physical processor. The correspondence between the logical processor and the physical processor is determined by the control OS 301.

The control OS 301 has a function to limit the amount of resources available to each logical partition. Limitation can be set to the amount of use of resources the guest OS 302 and the guest OS 303 can allocate and release without communicating with the system control OS 304.

Each logical partition includes a control signal port. A variety of control signals required for data exchanging and sharing between logical partitions reaches the control signal port. The control signals include

a) a request to connect event ports between logical partitions,

b) a request to connect message channels between logical partitions, and

c) a request to connect to a shared memory area.

The control signal reaching each logical partition is queued by the control signal port. No limit is set to the depth of the queue within a range permitted by a memory resource. The memory resource required for queuing is reserved from the logical partition receiving the control signal. To pick up the control signal from the port, a guest OS programming interface is called. When the control signal arrives at an empty control signal port, an event can be transmitted to any event port. The event port is specified by calling the guest OS programming interface.

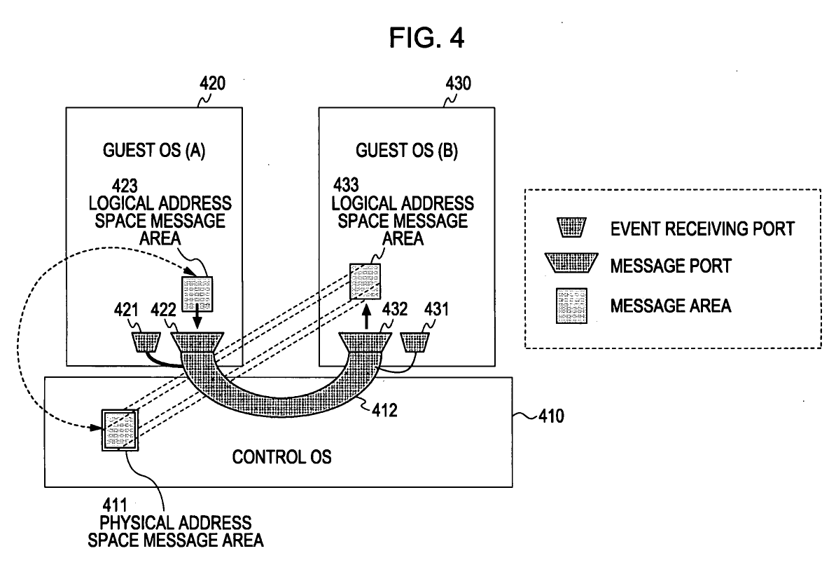

Referring to FIG. 4, inter OS communications are described below. The logical partitions are associated with the guest OS's and the system control OS. Message transfer between logical partition modules is performed via a message channel of the control OS.

Two communication processes of

(1) a communication process between the guest OS's and

(2) a communication process between the guest OS and the system control OS are described below.

[(1) Communication Process Between the Guest OS']

The communication process between the guest OS's is described first. FIG. 4 illustrates a concept of the communication process performed between two guest OS's on a control OS 410. A message is transferred from a guest OS(A) 420 to a guest OS(B) 430.

The control OS 410 sets a message channel 412 for communications between the guest OS's and between the guest OS and the system control OS. The message channel 412 is set up as a data transfer mechanism between two logical partitions, and is a connection-oriented two-way communication path.

Referring to FIG. 4, the communication process performed via the message channel 412 set by the control OS 410 between the guest OS(A) 420 and the guest OS(B) 430 is described. The guest OS(A) 420 is a client (connection source) of the message channel 412 and the guest OS(B) 430 is a server (connection destination) of the message channel 412.

The guest OS(A) 420 issues a message channel connection request to the guest OS(B) 430.

When the guest OS(B) 430 provides a message channel connection permit, the message channel 412 is established between the guest OS(A) 420 and the guest OS(B) 430 under the control of the control OS 410 as shown in FIG. 4. The message channel 412 is established as a channel connecting message ports 422 and 432 as connection terminals at guest OS's.

If the guest OS(B) 430 denies the message channel connection request, no message channel connection is established. The message ports 422 and 432 corresponding to the guest OS's are associated with event receiving ports 421 and 431, respectively.

The control OS 410 prepares an event mechanism for inter OS (logical partition) communications, and intra OS (logical partition) communications. An event is transmitted from an event transmitting port to an event receiving port on a one-to-one and one-way connection. The event receiving port neither queue the event nor count the event. For example, if a new event arrives at the event receiving port having the event remaining to be read, the event receiving port stays at a pending state. An event transmitting port having a connection established can transmit an event by an unlimited number of times. The event receiving port is a port via which the guest OS in the logical partition receives the event. The event arriving at the event receiving port is handled as an interrupt.

When a message channel is established between OS's (logical partitions) or when a message arrives at an empty message port, an event is delivered to an associated event receiving port.

If the guest OS(B) 430 permits the connection of the message channel, the message channel 412 is connected between the guest OS(A) 420 and the guest OS(B) 430 under the control of the control OS 410 as shown in FIG. 4. The guest OS(A) 420 then prepares a message area. A physical address message area 411 as a message area entity exists on a memory of the system.

The message area 423 of the guest OS(A) 420 and the message area 433 of the guest OS(B) 430 of FIG. 4 are logical address space message areas of the logical partitions of respective OS's. The physical address message area 411 belongs to a single logical partition at any given moment. The logical partition having no physical address message area 411 belonging thereto cannot access the message area.

More specifically, at any given moment, the physical address message area 411 is mapped to one of the logical address space message area 423 of the guest OS(A) 420 and the logical address space message area 433 of the guest OS(B) 430. The mapping control is performed by the control OS 410. The control OS 410 performs message transfer via the message channel 412 using a virtual address conversion mechanism from a logical address space to a physical address space.

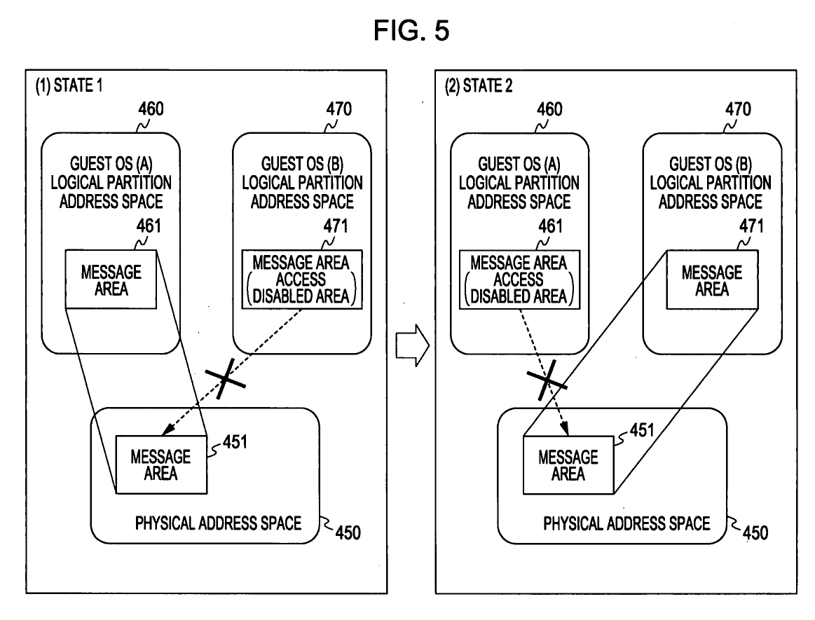

A message transfer process using a virtual address conversion mechanism is described below with reference to FIG. 5.

As shown in FIG. 5, state 1 is a state before the message transfer from a guest OS(A) to a guest OS(B) and state 2 is a state after the message transfer from the guest OS(A) to the guest OS(B). In the state 1, a message area 451 is mapped to a logical partition address space of a logical partition on a message transfer destination (client) side, namely, a message area 461 of a logical partition address space 460 of the guest OS (A). In the state 1, a logical area 471 of a logical partition address space 470 of the guest OS(B) cannot access the message area 451 of a physical address space 450.

The message area 451 is transferred. The message area 451, reserved in the physical address space 450, is unmapped (map released) from the logical partition address space 460 on the client side logical partition, namely, the logical partition address space 460 of the guest OS(A), and then mapped to a logical partition address space on the server side logical partition, namely, the logical area 471 of the logical partition address space 470. In other words, the state 2 of FIG. 5 is set up. In the state 2, accessing from a logical partition with the message area 451 belonging thereto, namely, accessing from the logical partition address space 460 of the guest OS(A) to the message area 451 of the physical address space 450 cannot be permitted.

The control OS maps the message area 451 reserved in the physical address space 450 to one of the logical partition address spaces of the guest OS's (logical partitions) set in the message ports of the message channel, and performs the unmapping process to the other logical partition address space. The control OS thus performs the message transfer by allowing the server to access the message from the client.

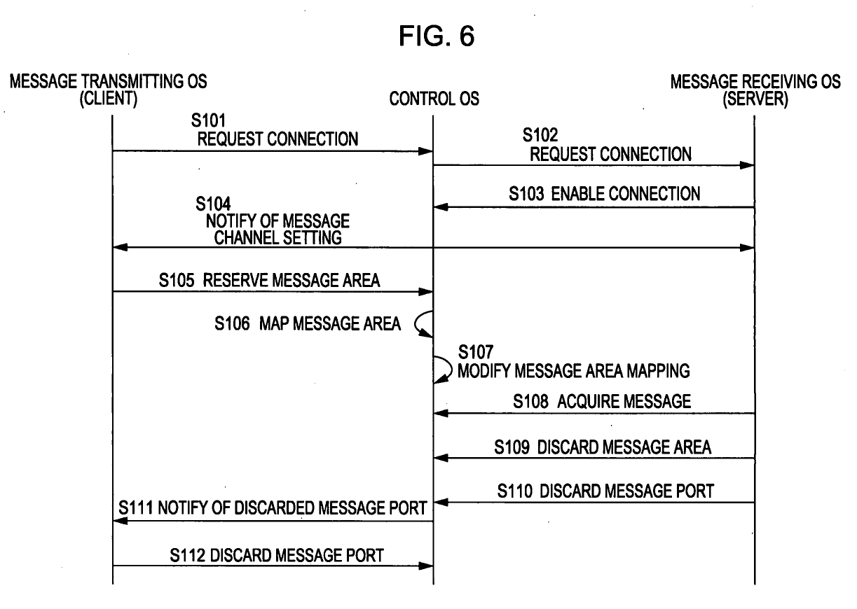

A message transfer sequence via the message channel between the guest OS's is described below with reference to FIG. 6.

In step S101, a message transmitting OS (client) transmits a connection request to a message receiving OS (server). The connection request is transmitted to the message receiving OS (server) via the control OS in step S102.

In step S103, the message receiving OS (server) permits connection in response to the reception of the connection request. The control OS generates a message channel with a message port set therewithin in each of the message transmitting OS (client) and the message receiving OS (server). Upon generating the message channel, the control OS notifies each OS of the completion of the setting of the message channel via the event receiving port associated with the message port in step S104.

In step S105, the message transmitting OS (client) reserves the message area, corresponding to the logical address space message area 423 of FIG. 5. In step S106, the control OS maps the message area of the physical address space to the logical partition address space of the message transmitting OS (client). This process step corresponds to a mapping process to map the logical address space message area 423 of the guest OS(A) 420 to the physical address message area 411 as shown in FIG. 4.

In step S107, the control OS unmaps (map releases) the message area of the physical address space from the logical partition address space of the logical partition of the message transmitting OS (client). The control OS then maps the message area of the physical address space to the logical partition address space of the logical partition of the message receiving OS (client). More specifically, as shown in FIG. 4, the mapping of the logical address space message area 423 of the guest OS(A) 420 to the physical address message area 411 is released, and the physical address message area 411 is mapped to the logical address space message area 433 of the guest OS(B) 430.

In step S108, the message receiving OS (server) accesses the message area of the physical address space via the logical partition address space of the logical partition of the message receiving OS (server) and acquires a message.

In step S109, the message receiving OS (server) discards the message area. In step S110, the message receiving OS (server) discards the message port. In step S111, the notification of discarding of the message port is transmitted to the message transmitting OS (client) using the event receiving port. In step S112, the message transmitting OS (client) discards the message port. The message channel is thus discarded, and the inter OS communication using the message channel is completed.

[(2) Communication Process Between the Guest OS and the System Control OS]

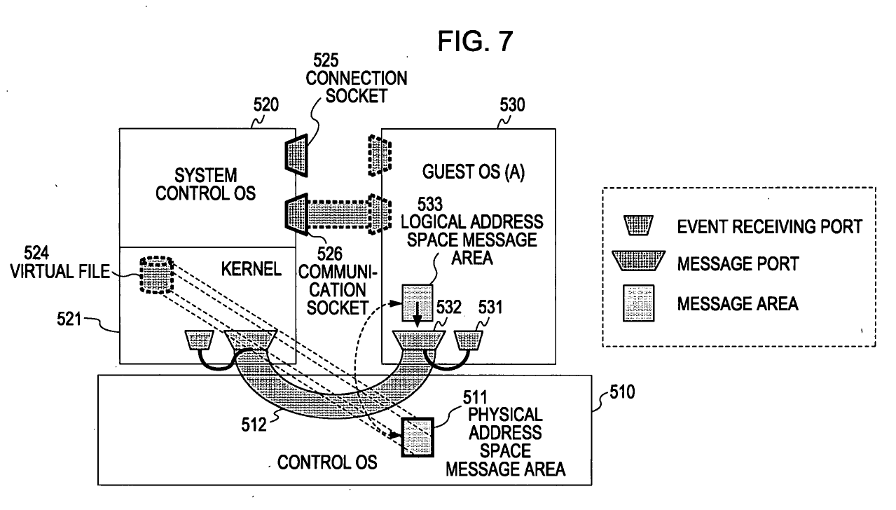

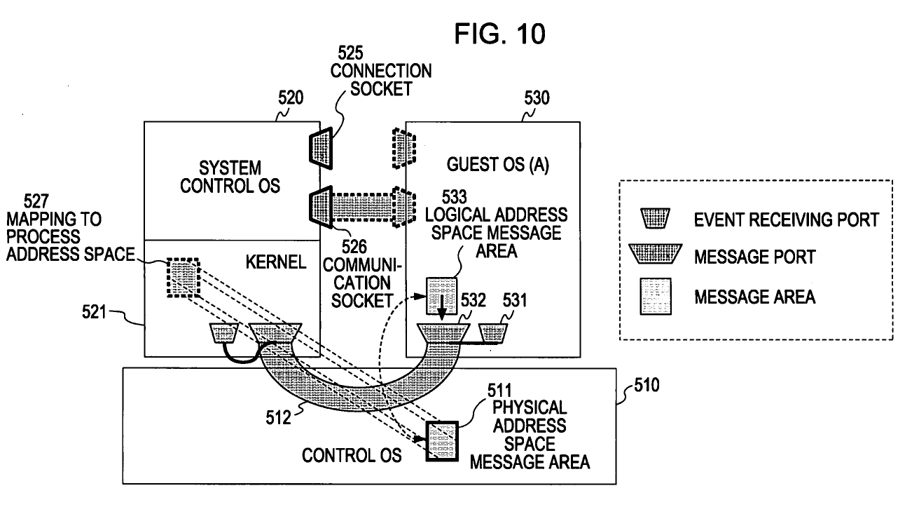

The communication process performed between the system control OS and the guest OS is described below with reference to FIGS. 7 and 10. As previously discussed, the system control OS generates a system control program, and controls the entire system based on upper limit information of resource budget predetermined in the system.

The guest OS transfers a message to the system control program set in the system control OS in order to perform a variety of processes in response to resource requests to the logical partition set in the guest OS.

In the above-referenced inter guest OS communication, the message transfer is performed to map and unmap the logical address space corresponding to the logical partition set in each guest OS to the message area in the physical address. A message channel 512 generated by the control OS 510 of FIG. 7 is used in the communication process between the system control program set in the system control OS and the guest OS. A system control OS 520 generates a UNIX (registered trademark) socket applied to communications and communicates via a message channel.

If communications are performed using a virtual file as shown in FIG. 7, the system control OS generates a socket associated with a file descriptor identified by a file system managed by own OS, and produces a virtual file accessed via the socket. Accessing to the physical address space message area is performed via the virtual file to exchange messages.

If communications are performed with no virtual file used as shown in FIG. 10, the system control OS generates a socket associated with a file descriptor identified by a file system managed by own OS, and maps a message area in the physical address space to an address space of a process via the socket. The process directly accesses the message area.

The UNIX (registered trademark) sockets include one for use in communications with the process in the system (UNIX domain socket) and one for use in communications with another system via a network (Internet domain socket). The system control OS provides a message channel as a socket of a new domain to the system control program. The system control program can perform communications using the message channel at the same semantic socket as the existing one.

The communication process using the known UNIX socket (UNIX domain socket) is performed as below.

a) A message receiving (server) process generates a socket in response to a socket system call.

b) The message receiving (server) process allocates a name (file descriptor) corresponding to the socket in response to a bind system call.

c) The message receiving (server) process executes a listen system call, and sets connection ready state.

d) A message transmitting (client) process generates a socket in response to a socket system call, and establishes a server side socket using a connect system call.

e) The message receiving (server) process executes an accept system call, and accepts a request from the message transmitting (client) process.

f) Subsequent to the completion of connection, messages are exchanged using a write system call as a write process to the file descriptor corresponding to the socket, and a read system call as a read process.

The communication sequence using the socket of UNIX (UNIX domain socket) has been discussed. In accordance with the present invention, the message channel 512 set by the control OS 510 of FIGS. 7 and 10 is used. A process substantially identical to the process using the above-described socket is performed on the system control program to communicate with the guest OS. On the side of the guest OS, a process substantially identical to the previously described inter guest OS communications is performed.

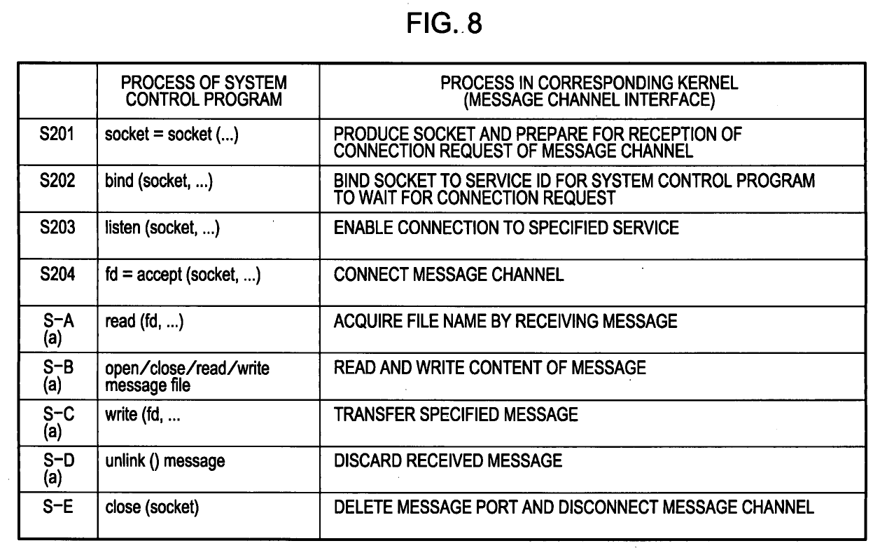

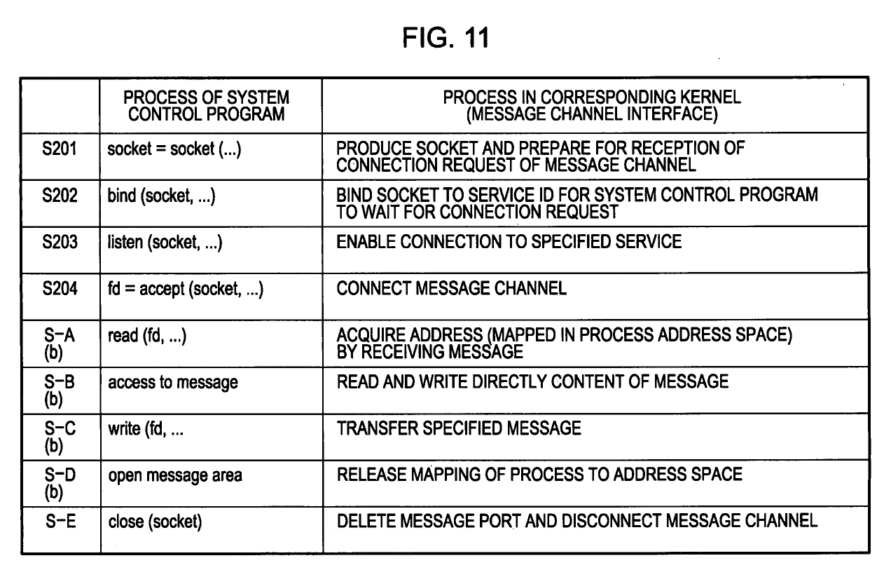

A communication process sequence of the system control OS 520 and the guest OS 530 is described below with reference to FIGS. 7 and 8 (illustrating a communication with a virtual file used) and FIGS. 11 and 2 (illustrating a communication with a virtual file unused). The system control program set by the system control OS 520 and the guest OS actually perform the communication process. In the communication process, the message channel 512 generated by the control OS 510 and a communication socket generated by a system control program kernel 521 are used. The system control program executes a variety of system calls, and the system control program kernel 521 executes a process in response to the system call. The system control program kernel 521 sets communication environments and a communication control process. The system control program uses the communication socket generated by the system control program kernel 521, thereby communicating with the guest OS at a process substantially identical to the communication using the above-described UNIX socket.

FIGS. 8 and 11 illustrate the process of the system control program executing communications with the guest OS and the process of the kernel. Steps of the process are described below.

[Step S201]

In step S201, the system control program starts a socket system call “socket ( )” to generate a connection socket to receive a connection request. The system call is used to call the functions of the system control program kernel 521. In response to the initiation of the socket system call “socket ( )”, the system control program kernel 521 generates a connection socket 525 of FIGS. 7 and 10.

The generated socket corresponds to a file name (file descriptor) set in the file system managed by the system, control OS 520.

[Step S202]

In step S202, the system control program initiates a bind system call “bind (socket, . . . )”. In response to the bind system call, the system control program kernel 521 associates a service ID (port number) for waiting for a connection request of the system control program with the socket. Each socket is thus associated with service provided by the system control program.

[Step S203]

In step S203, the system control program initiates a listen system call “listen (socket, . . . )”. The system control program kernel 521 permits a connection of service corresponding to the socket in response to the listen system call. The socket is provided with an identifier corresponding to the service. The system control program executes communication permit setting corresponding to the service.

[Step S204]

In step S204, the system control-program initiates an accept system call (fd=accept (socket, . . . )). The system control program kernel 521 examines the presence or absence of the connection request of the message channel in response to the accept system call to check whether the connection request of a connection message channel has arrived.

If the connection request has arrived, the following process steps (a) through (c) are performed.

(a) A communication socket (a communication socket 526 of FIGS. 7 and 10) is produced.

(b) A file descriptor (fd) corresponding to the socket is registered in a file descriptor table (fd_table) of a file system managed by the system control OS 520.

(c) The registered file descriptor (fd) corresponding to the socket is returned to the system control program.

If the connection request have not arrived, the following process steps (d) and (e) are performed.

(d) The process is set to be in a suspended state.

(e) The process is released from the suspended state when a next connection request arrives, and then the above-referenced process steps (a)-(c) are performed.

The message channel is thus established between the system control program and the guest OS. A virtual file 524 of FIG. 7 is a file in an abstract form of a physical address space message area 511 managed by the control OS 510. A file generation process and a file deletion process are performed by the system control OS 520. A message is now transferred from the guest OS 530 to the system control program. Prior to the message transfer, a logical address space message area 533 of the guest OS 530 is mapped to the physical address space message area 511. Subsequent to the message transfer, the physical address space message area 511 becomes the virtual file 524 on the system control OS 520, and becomes accessible by the system control program. In the message transfer from the system control program to the guest OS 530, the virtual file 524 on the system control OS 520 becomes accessible by the system control program prior the message transfer. Subsequent to the message transfer, the system control OS 520 deletes the virtual file, and the physical address space message area 511 is mapped to the logical address space message area 533 of the guest OS 530.

To map the physical address space message area 511 directly to the address space of the process rather than via the virtual file 524, the following process is performed. In the message transfer from the guest OS 530 to the system control program, the logical address space message area 533 of the guest OS 530 is mapped to the physical address space message area 511 prior to the message transfer. Subsequent to the message transfer, the system control OS 520 maps the physical address space message area 511 to the address space of the process so that the system control program can perform direct access. In the message transfer from the system control program to the guest OS 530, the system control OS 520 maps the physical address space message area 511 to the address space of the process so that the system control program can perform direct access. Subsequent to the message transfer, the system control OS 520 releases the mapping, and maps the physical address space message area 511 to the logical address space message area 533 of the guest OS 530.

If the virtual file is used, the system control program acquires an identifier of the virtual file 524 corresponding to the socket in response to the read system call specifying the file descriptor of the communication socket. The system control program uses one of the system calls (open, close, read, and write system calls) specifying the virtual file, thereby opening or closing the file corresponding to the socket, or writing or reading the message.

The physical address space message area 511 can be mapped directly to the address space of the process rather than via the virtual file 524. In response to the read system call specifying the file descriptor of the communication socket, the system control program acquires an address of the address space of the process to which the physical address space message area 511 is mapped. By directly accessing the address, the system control program can perform a read process and a write process to the message area.

The system control program sets a plurality of sockets. Individual virtual files are set to respective sockets, and each virtual file can be individually associated with the message area in the physical address space for communication. (The same is true if the physical address space message area, rather than the virtual file, is directly mapped to the address space of the process.) The socket is associated with a service identifier. By selectively performing the system call specified by the socket, individual processes of the socket (service), such as communication permission, communication denial, or the like, are performed.

Process steps S-A through S-E of FIGS. 8 and 11 are executable at any timing subsequent to the generation of the message channel in steps S201 through S204. Each process step is described below.

[Step S-A]

Step S-A is a message reception step for receiving a message from the guest OS. The system control program initiates a read system call (read (fd, . . . )) to receive the message. The system control program kernel 521 examines the presence or absence of a message that has arrived via the message channel from the guest OS in response to the read system call.

To perform a communication process using the virtual file, the following process steps (a) and (b) are performed after the message has arrived.

(a) A virtual file is produced in response to the arrival message 524 of FIG. 7.

(b) An identifier (ID) of the virtual file corresponding to the arrival message area and a short message are copied to a user buffer. In other words, the identifier and the short message are transferred to the system control program. In response to the identifier of the virtual file, the system control program reads the message by specifying the virtual file.

If the message has not arrived, the following process steps (c) and (d) are executed.

(c) The process is set to be in a suspended state.

(d) The process is released from the suspended state when the message has arrived, and the process steps (a) and (b) are performed.

The virtual file 524 of FIG. 7 is identified by a file descriptor (fd) corresponding to the socket, and compatible with the physical address space message area 511 managed by the control OS 510.

In communications not using the virtual file (with the physical address space message area 511 directly mapped to the address space of the process), the message area is mapped to the address space of the process, and the address and the size of the message area are copied to a user buffer. In other words, the system control program is notified of the address and the size. Based on the address, the system control program directly reads the content of the message area.

[Step S-B]

Step S-B is a process step to access the message. A communication process using the virtual file is a process to be performed to the virtual file 524. The system control program initiates, as the process to be performed to the virtual file 524, one of the system calls (open, close, read, and write system calls). The system control program kernel 521 executes the process corresponding to each of the system calls. In response to the open and close system calls, the virtual file 524 is opened and closed, respectively. In response to the write system call, data writing is performed onto the virtual file 524. In response to the read system, data reading is performed from the virtual file 524. These processes are performed as processes by specifying the file descriptor.

In communications not using the virtual file (with the physical address space message area mapped to the address space of the process), the system control program can directly access the message area mapped to the address space of the process.

[Step S-C]

Step S-C is a process to be performed to transmit a message.

In communications using the virtual file, the message written on the virtual file 524 is transmitted. The system control program initiates the write system call (write(fd, . . . )) specifying the ID of the virtual file corresponding to the communication socket. In response to the write system call (write(fd, . . . )), the system control program kernel 521 transmits the message written on the virtual file 524.

In response to the process executed by the system control program kernel 521 based on the write system call (write(fd, . . . )), the control OS 510 deletes the virtual file 524 on the system control OS 520 corresponding to the physical address space message area 511, and maps the physical address space message area 511 to the logical address space message area 533 on the guest OS 530. In this process, the message the system control program has written using the virtual file 524 is transferred to the guest OS 530. The process of the guest OS 530 is performed using a message port 532 and an event port 531 in the same manner as previously discussed.

In communications not using the virtual file (with the physical address space message area directly mapped to the address space of the process), the system control program initiates the write system call (write(fd, . . . )) to the communication socket. The write system call specifies the address at which the physical address space message area is mapped to the address space of the process. In response to the write system call (write(fd, . . . )), the system control program kernel 521 executes the transmission process to the physical address space message area. The mapping to the process address of the message area is released during the transmission process.

[Step S-D]

Step S-D is a process step to delete a received message.

In communications using the virtual file, the system control program initiates an unlink system call (unlink ( )) to the virtual file 524. In response to the unlink system call (unlink ( )), the system control program kernel 521 discards the message by deleting a file identifying the received message.

In communications not using the virtual file, the mapping to the address space of the process is simply released, and the physical address space message area is released.

[Step S-E]

Step S-E is a process step to disconnect the message channel. The system control program initiates the close system call (close(socket)) specifying the socket. The system control program kernel 521 deletes the message port, thereby disconnecting the message channel.

The system control program monitors the message transmission and reception process in response to a select system call (select) although the message transmission and reception process is not shown in FIGS. 8 and 11. By initiating the select system call identifying the file descriptor corresponding to the socket, the system control program kernel 521 constantly monitors the presence or absence of the received message corresponding to the socket identified by the select system call, like another input and output process. For example, the system control program performs a communication process with communication sockets different from guest OS to guest OS of a plurality of guest OS's. The system control program specifies, as targets of the select system call, a communication socket (fd=s0) with the guest OS(A) and a communication socket (fd=s1) with the guest OS(B). The system control program kernel 521 thus monitors the presence or absence of the message to each socket. If a message is present, the system control program kernel 521 notifies the system control program of the presence of the message. Using the select system call (select), efficient processing is performed.

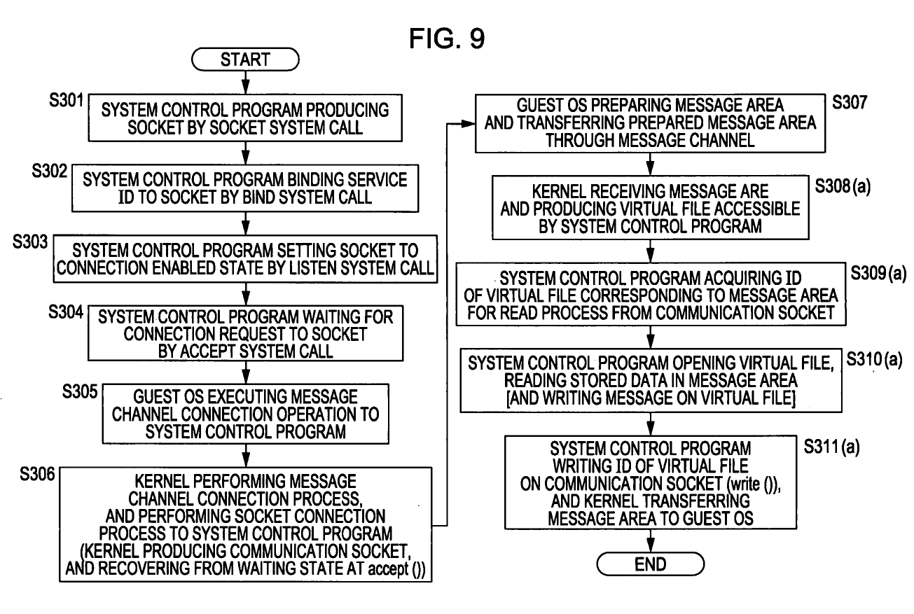

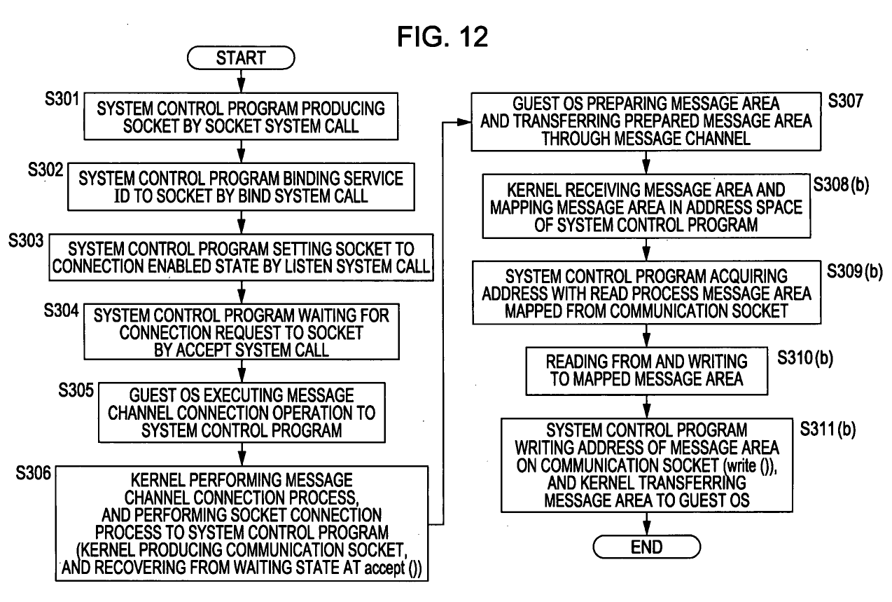

The process of the system control program and the guest OS are described below with reference to flowcharts of FIGS. 9 and 12. In the process, the system control program transmits a message to and receives a message from the guest OS.

In step S301, the system control program generates a socket (socket( )) in response to the socket system call. The socket here corresponds to the socket 525 of FIG. 7.

In step S302, the system control program attaches a service ID to the socket in response to the bind system call (bind( )). The socket herein is set to be associated with the service provided by the system control program.

In step S303, the system control program sets the socket to be in a connection permitted state in response to the listen system call (listen( )). By issuing the listen system call identifying the socket, the system control program can set the socket to be in the connection permitted state or connection unpermitted state.

In step S304, the system control program waits for a connection request to the socket by the accept system call (accept( )).

In step S305, the guest OS performs a message channel connection operation to the system control program.

The message channel connection operation includes the following process steps (a) and (b).

(a) The guest OS performs a connection request process (corresponding to the connection request process in step S101 in the sequence chart of FIG. 6).

(b) The control OS notifies the system control program of the connection request. In response to the accept system call in step S304 as previously discussed, the guest OS is notified of the message channel setting notification from the control OS (corresponding step S104 of FIG. 6).

In step S306, the kernel on the system control program connects the message channel while performing a connection process to the socket to the system control program. More specifically, the kernel produces the communication socket, and recovers from the waiting state at the accept system call (accepst( )).

In step S307, the guest OS prepares the message area, and transfers the message area via the message channel. This process includes the following process steps a) and b).

a) The guest OS reserves a message area. More specifically, the guest OS sets a message area in a logical address space of the logical partition corresponding to the guest OS.

b) The message area of the logical address space of the guest OS is mapped to the message area of the physical address space.

In communications using the virtual file, the kernel on the system control program receives the message area transmitted from the guest OS in step S308(a), and produces a virtual file accessible by the system control program. The virtual file is the virtual-file 524 of FIG. 7. A virtual file ID is attached to the generated virtual file. The control OS associates the message area of the physical space with the virtual file 524 produced by the kernel on the system control program.

In communications with no virtual file used, in step S308(b), the kernel on the system control program receives the message area transmitted from the guest OS, and maps the message area to the address space of the system control program.

In communications with the virtual file used, the system control program acquires the ID of the virtual file corresponding to the message area in accordance with the read system call (read( )) specifying the communication socket in step S309(a). The virtual file ID is a file name, for example.

In step S310(a), the system control program opens the virtual file using the open system call (open( )) specifying the virtual file ID, and reads the data stored in the message area using the read system call (read( )).

The system control program uses the write system call (write( )) to the opened virtual file, thereby writing data onto the virtual file.

In communications with the virtual file not used, the system control program directly accesses the message area mapped to the address space of own program (steps S309(b) and S310(b)).

The system control program specifies the communication socket in one of steps S311(a) and S311(b). The system control program executes the write-system call (write( )) as a write process to the address in the process address space with one of the ID of the virtual file and the physical address space message area mapped thereto. The kernel then transfers the message area to the guest OS. In response to the process, the control OS deletes the virtual file on the system control program or unmaps the message area of the physical address space mapped to the address space of the process. The control OS maps the message area to the message area of the logical partition of the guest OS. After this process, the guest OS can and does read the message.

In the communication process between the system control program and the guest OS, the system control program executes the communication process using the socket, thereby communicating with the guest OS via the communication channel set by the control OS.

The present invention has been described with reference to particular embodiments. Modifications and changes of the embodiments within the scope of the present invention are apparent to those skilled in the art. The embodiments of the present invention have been discussed for exemplary purposes only, and are not intended to limit the scope of the invention. The scope of the invention is limited by the appended claims only.

The above-references series of steps can be performed using software, hardware, or a combination thereof. If the series of steps is performed using software, a program forming the software is installed from a recording medium or via a network onto a computer incorporated into a hardware structure or to a general-purpose computer performing a variety of processes, for example.

The program can be recorded beforehand onto one of a hard disk and a ROM (read-only memory) as a recording medium. The program can also be stored (recorded) on a removable recording media temporarily or permanently. The recording media includes a floppy disk, a CD-ROM (compact disk read-only memory), a MO (magneto-optic) disk, a DVD (digital versatile disk), a magnetic disk, a semiconductor memory, etc. Such a removable medium can be supplied in package software.

The program can be installed from the removable recording medium to the computer. The program can be transmitted in a wireless fashion to the computer from a download site. The program can also be transmitted in a wired fashion via a network such as one of a LAN (local area network) and the Internet. The program is then received by the computer and installed onto a recording medium such as a hard disk in the computer.

The process steps discussed in this description are sequentially performed in the time series order as stated. Alternatively, the steps may be performed in parallel or separately. In this specification, the system refers to a logical system composed of a plurality of apparatuses, and the elements of each apparatus are not necessarily contained in the same casing.

### INDUSTRIAL APPLICABILITY

In accordance with embodiments of the present invention, the control OS performs communication control among OS's in a multi-OS environment where a plurality of operating systems (OS's) coexist. The control OS controls message transfer between logical partitions set corresponding to OS's. The message area in the physical address space is switched from the mapping state to the message area in the logical partition address space in the message transmitting OS to the mapping state to the message area in the logical partition address space in the message receiving OS. The message transfer control is thus performed between OS's. Smooth communications are possible among different OS's.

In accordance with embodiments of the present invention, the communication executing OS generates the socket associated with the file descriptor identified by the file system managed by own OS, sets the virtual file accessed via the socket, and transmits and receives a message via the virtual file, or transmits or receives a message by mapping the message area in the physical address space to the address space of a process. Message passing is performed using a general socket among different OS's.

In accordance with embodiments of the present invention, the identifier of the service corresponding to the socket is set so that communication permission is set for the service. The reception monitoring process via the socket is performed via the socket using the select system call.

1. An information processing apparatus comprising a plurality of operating systems (OS's), the plurality of OS's including a control OS controlling communications between the plurality of OS's, the control OS controlling message transfer between logical partitions set up for respective communication executing OS's, by switching a message area in a physical address space from a mapping state to a message area in a logical partition address space in a message transmitting OS to a mapping state to a message area in a logical partition address space in a message receiving OS.

2. The information processing apparatus according to claim 1, wherein at least one of the communication executing OS's in communication operation generates a socket associated with a file descriptor identified by a file system managed by own OS, generates a virtual file accessed via the socket, and accesses the message area in the physical address space via the virtual file.

3. The information processing apparatus according to claim 2, wherein the communication executing OS in communication operation using the socket acquires an identifier of the virtual file associated with the socket, and performs one of a message write operation and a message read operation using the virtual file identified by the acquired virtual file identifier.

4. The information processing apparatus according to claim 1, wherein at least one of the communication executing OS's in communication operation generates a socket associated with a file descriptor identified by a file system managed by own OS, and maps the message area in the physical address space to an address space of a process via the socket so that the process directly accesses the message area.

5. The information processing apparatus according to claim 1, wherein at least one of the communication executing OS's in communication operation generates a socket associated with a file descriptor identified by a file system managed by own OS, and maps the message area in the physical address space to an address space of a logical partition corresponding to the communication executing OS via the socket in order to access the message area.

6. The information processing apparatus according to one of claims 2 through 5, wherein the communication executing OS in communication operation using the socket sets an identifier of service corresponding to the socket, and sets communication permission corresponding to the service.

7. The information processing apparatus according to one of claims 2 through 5, wherein the communication executing OS in communication operation using the socket performs a reception monitoring process on a message via the socket.

8. The information processing apparatus according to claim 7, wherein the communication executing OS performs the reception monitoring process on the message via the socket by applying a select system call.

9. A communication processing method of an information processing apparatus storing a plurality of operating systems (OS's), comprising:
a step of setting a message area in a physical address space to a mapping state to map to a message area in a logical partition address space of a message transmitting OS, and
a step of releasing the mapping state and setting the message area in the physical address space to a mapping state to map to a message area in a logical partition address space of a message receiving OS.

10. The communication processing method according to claim 9, wherein at least one of the communication executing OS's performing message transfer generates a socket associated with a file descriptor identified by a file system managed by own OS, generates a virtual file accessed via the socket, and accesses the message area in the physical address space via the virtual file in order to perform message transfer.

11. The communication processing method according to claim 10, wherein the communication executing OS in communication operation using the socket acquires an identifier of the virtual file associated with the socket, and performs one of a message write operation and a message read operation using the virtual file identified by the acquired virtual file identifier.

12. The communication processing method according to claim 9, wherein at least one of the communication executing OS's in communication operation generates a socket associated with a file descriptor identified by a file system managed by own OS, and maps the message area in the physical address space to an address space of a process via the socket so that the process directly accesses the message area.

13. The communication processing method according to claim 9, wherein at least one of the communication executing OS's in communication operation generates a socket associated with a file descriptor identified by a file system managed by own OS, and maps the message area in the physical address space to an address space of a logical partition corresponding to the communication executing OS via the socket in order to access the message area.

14. The communication processing method according to one of claims 9 through 13, wherein the communication executing OS in communication operation using the socket sets an identifier of service corresponding to the socket, and sets communication permission corresponding to the service.

15. The communication processing method according to one of claims 9 through 13, wherein the communication executing OS in communication operation using the socket performs a reception monitoring process on a message via the socket.

16. The communication processing method according to claim 15, wherein the communication executing OS performs the reception monitoring process on the message via the socket by applying a select system call.

17. A computer program for controlling communications in an information processing apparatus storing a plurality of operating systems (OS's), comprising:
a step of setting a message area in a physical address space to a mapping state to map to a message area in a logical partition address space of a message transmitting OS, and
a step of releasing the mapping state and setting the message area in the physical address space to map to a message area in a logical partition address space of a message receiving OS.

18. A computer program for controlling communications in an information processing apparatus storing a plurality of operating systems (OS's), comprising:
a step of generating a socket associated with a file descriptor identified by a file system managed by own OS,
a step of generating a virtual file accessed via the socket, and
a step of accessing the message area in the physical address space via the virtual file in order to perform message transfer.

19. A computer program for controlling communications in an information processing apparatus storing a plurality of operating systems (OS's), comprising:
a step of generating a socket associated with a file descriptor identified by a file system managed by own OS,
a step of mapping the message area in the physical address space to an address space of a process via the socket, and
a step of accessing directly the message area.
